(19) United States
(12) Patent Application Publication
(10) Pub. No.: US 2021/0396194 A1
(43) Pub. Date: Dec. 23, 2021

(54) Electromagnetic Propulsion System

(71) Applicant: Kenneth Neal, Chicago Heights, IL (US)

(72) Inventor: Kenneth Neal, Chicago Heights, IL (US)

(21) Appl. No.: 17/324,185

(22) Filed: May 19, 2021

Related U.S. Application Data
(60) Provisional application No. 63/040,231, filed on Jun. 17, 2020.

(51) Int. Cl. F02K 5/00; F01D 15/10; F01D 5/28

(52) U.S. Cl. CPC F02K 5/00; F01D 15/10; F05D 2300/611; F05D 2220/76; F01D 5/288

(57) ABSTRACT

This present invention relates to an electromagnetic propulsion system comprised of a plurality of electromagnets for powering an alternator, and a turbo fan inside a container specially designed to release heat and pressure therefrom via a plurality of vents in the container. More specifically, a plurality of sensors on the electromagnets detect the position of the alternator and generate electricity for the vehicle, watercraft or aircraft, and creates air in the chamber that is then vented to manipulate movements of the vehicle, watercraft or aircraft.

### CROSS-REFERENCE TO RELATED APPLICATION

The present application claims priority to, and the benefit of, U.S. Provisional Application No. 63/040,231, which was filed on Jun. 17, 2020 and is incorporated herein by reference in its entirety.

### BACKGROUND OF THE INVENTION

The present invention relates generally to the field of motive force providers that produce a propulsive force for use with aircraft, vehicles, watercraft, automobiles and the like, and which require some sort of propulsion to move. In particular, the present invention relates to an improved propulsion system equipped with electromagnets to power the alternator and provide thrust to the vehicle or craft. More specifically, the plurality of electromagnets propel a turbo fan to create a desired thrust, wherein the system has sensors on the electromagnets which are used to detect the position of the magnets on the armature of the alternator. The sensors may also turn on or off the alternator that provides power for the batteries, which has a shaft connection to a turbo fan. The turbo fan creates a compressed and heated airflow in a chamber which is used to manipulate movements for the aircraft, watercraft, automobiles, trucks or vehicle employing the system. Accordingly, the present specification makes specific reference thereto. However, it is to be appreciated that certain aspects of the present invention are also equally amenable to other like applications, devices and methods of manufacture.

By way of background, fossil fuels are hydrocarbons, primarily coal, fuel oil, or natural gas, formed over millions of years from the remains of dead plants and animals. The term fossil fuel also includes hydrocarbon-containing natural resources that are not derived from animal or plant sources. The burning of fossil fuels by humans is the largest source of emissions of carbon dioxide, which is one of the greenhouse gases that allows radiative forcing and contributes to global warming.

Standard engine systems used in automobiles, aircraft, watercraft, heavy equipment and the like rely heavily upon fossil fuels for power, which can be harmful to the environment. Further, hydrocarbon based fuels are the primary fuels employed to power internal combustion engines such as those referenced above, and such fuels are derived from a limited supply of oil and other natural resources located earth. As the human population continues to grow exponentially, the use of internal combustion engines and the demand for hydrocarbon-based fuels to power those internal combustion engines also increases. Therefore, it is highly unlikely that the production of hydrocarbon-based fuels from the limited supply of oil and other natural resources can keep pace with the growing demands of an increasing population, and new technologies for powering vehicles, aircraft, watercraft, heavy equipment and the like will be needed.

Additionally, while aircraft engines produce emissions that are similar to other emissions resulting from fossil fuel combustion, a significant portion of aircraft emissions are emitted into the atmosphere at a relatively high altitude. These emissions give rise to important environmental concerns regarding their global impact and their effect on local air quality at ground level, particularly around airports. In addition, a large amount of fuel is wasted in heat. For example, it is estimated that two-thirds to three-quarters of fuel energy transforms into heat, or is lost via exhaust. Still other fuel is lost to evaporation on days having high temperatures, thereby further contributing to the inefficiency of fossil fuels.

Therefore, there exists a long felt need in the art for an improved and more efficient propulsion system for use in aircraft, commercial vehicles, recreational vehicles, and the like. There is also a long felt need in the art for an improved and efficient propulsion system that does not rely solely on fossil fuels for power, and that is powered in part by the electricity generated by a plurality of the electromagnets used in a power generation system. Additionally, there is a long felt need in the art for an improved and efficient propulsion system that utilizes a plurality of electromagnets having sensors to turn on, turn off and/or monitor an alternator and the performance of the system. Moreover, there is a long felt need in the art for an improved and more efficient propulsion system that is environmentally friendly, and that can be used in a plurality of different applications, such as in aircraft, automobiles, watercraft, heavy equipment and the like. Finally, there is a long felt in the art for an improved and efficient propulsion system that is relatively inexpensive to manufacture, and that uses a plurality of electromagnets to generate and help power an alternator, which in turn provides power to the vehicle's battery or batteries.

The subject matter disclosed and claimed herein, in one embodiment thereof, is an electromagnetic propulsion system for use in an aircraft, automobile, watercraft or the like, and that comprises an alternator with an armature, and a plurality of electromagnets positioned on the armature of the alternator. The electromagnets further comprise a plurality of sensors that enable a connecting computing device to detect the position of the alternator in real time, control the operation of the alternator, and switch on or off the alternator depending on the load of the system and other performance criteria. In turn, the alternator generates electricity and powers the batteries of the aircraft, automobile, watercraft, etc. The system further includes a turbo fan to release the heat and pressure created in a chamber, wherein the power generated by the heat and pressure is moved outside the chamber and the vehicle via vents, and is used to manipulate the movement of the aircraft, automobile, watercraft, etc. The electromagnetic propulsion system provides a greener and more efficient propulsion system for use in aircraft, commercial vehicles, recreational vehicles, automobiles, and the like, and is less dependent on fossil fuels.

In this manner, the electromagnetic propulsion system of the present invention accomplishes all of the forgoing objectives, and substantially departs from the concepts and designs of the conventional fossil fuel based engine systems. In so doing, the electromagnetic propulsion system of the present invention provides a more environmentally friendly system primarily developed for the purpose of powering aircraft, watercraft, trucks, other vehicles and automobiles which utilize an engine or other motive force provider.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

As used herein, the term “aircraft” refers to a vehicle that is able to fly by gaining support from the air, and that counters the force of gravity by using either static lift or by using the dynamic lift of an airfoil, or, in some instances, the downward thrust from jet engines. The term “vehicle” refers to a wheeled motor vehicle used for transportation or the transporting of goods. “Watercraft” refers to a craft that travels on water, and that requires a propulsive force to move the craft forward.

The subject matter disclosed and claimed herein, in one embodiment thereof, comprises an electromagnetic propulsion system for use in an aircraft, vehicle, watercraft, or other device comprising an alternator and a turbo fan. More specifically, the alternator is connected to the turbo fan through a shaft or direct drive connection, and a plurality of electromagnets are provided for powering the alternator and propelling the turbo fan. Additionally, the plurality of electromagnets have sensors to detect the position of the electromagnets on the armature of the alternator, wherein the alternator powers the batteries and the turbo fan creates compressed and heated air in a chamber which is, in turn, vented out of the rear of the chamber and used to move or guide the aircraft, vehicle or watercraft in a desired direction with a thrust.

In a further embodiment of the present invention, a method for providing electrical power to the batteries of an aircraft, vehicle or watercraft is disclosed and comprises the steps of providing a system including an alternator having an armature with a plurality of electromagnets disposed on the armature. More specifically, the plurality of electromagnets power the alternator and propel a turbo fan, wherein a plurality of sensors are disposed in the electromagnets to detect the position of the various electromagnets on the armature in real time. The turbo fan in turn releases the heated and pressurized air from a chamber and through a plurality of vents to manipulate the movement of the aircraft, watercraft or the vehicle. A communication means is also provided for the sensors to communicate with a computing device (e.g., a computer) to transmit positional information of the alternator to control the power provided or transmitted to the batteries and the operation of the alternator.

In a further embodiment of the present invention, an improved propulsion system and alternator combination for use in an aircraft, vehicle, watercraft and the like is disclosed. The combination is comprised of a plurality of electromagnets positioned on the armature of an alternator to power the alternator. The alternator in turn provides power for the batteries of the aircraft, watercraft, vehicle, etc., and a turbo fan inside a chamber is designed to release heat and pressure via vents positioned at the rear of the chamber when the pressure within the chamber reaches a predetermined level to provide a propulsive force to manipulate movements of the aircraft, vehicle or watercraft.

In yet another embodiment of the present invention, a chamber present on an aircraft or vehicle is disclosed and comprises a turbo fan at a proximal end of the chamber, and vents at the distal end of the chamber. The turbo fan is connected to an alternator through a shaft connection, and the turbo fan rotates at a relative high speed to create a directional airflow of heated and pressurized air within the chamber. The air within the chamber is then discharged through the plurality of vents to manipulate movement of the aircraft, watercraft or vehicle.

In yet another embodiment of the present invention, a method for providing power to the batteries of a vehicle, aircraft, watercraft or the like is disclosed. The method comprises the steps of positioning a plurality of electromagnets on an armature of an alternator. The electromagnets further comprise a plurality of sensors disposed thereon for detecting the position of the electromagnets, wherein the positional information of the electromagnets is then provided to a computing device to deduce the position and orientation of the armature in real time. Next, power is provided to the batteries by the armature in accordance with the detected position and orientation of the electromagnets, and compressed air being expelled though a plurality of vents in a chamber is used to provide thrust to the vehicle.

In yet a further embodiment of the presently described invention, an electromagnetic propulsion device for an aircraft is described. The electromagnetic propulsion device comprises at least one propulsion system having an alternator, an armature enclosed within the alternator, a fan, a chamber and a nozzle. The fan has a series of blades and is connected to a shaft that is driven by the alternator. A plurality of electromagnets are disposed about a periphery of the alternator, and a plurality of sensors are magnetically coupled to the blades of the fan. The plurality of sensors provide information relating to at least one of a position, speed, pressure, temperature, air flow velocity, air particulate information, and component wear to a system for monitoring the performance of the system. The fans are used to generate air inside of the chamber that creates pressure, which is in turn used to manipulate movement.

In a still further embodiment of the present invention, a motive force generator is disclosed and includes a system having an alternator, an armature enclosed within the alternator, a fan, a chamber and a nozzle. The fan has a series of blades and the fan is connected to a shaft that is driven by the alternator. A pulley is provided to facilitate rotation of the armature and change as speed levels increase or decrease. A plurality of sensors are magnetically coupled to the blades of the fan, and said plurality of sensors provide information relating to at least one of a position, speed, pressure, temperature, air flow velocity, air particulate information, and component wear to a computer system for monitoring the performance of the propulsion system. A motive force of air generated by an electric motor is also expelled through the nozzle as monitored by the system.

The alternator of the present invention works together with the batteries to supply power for the electrical components of the vehicle. More specifically, when the alternator is rotated, alternating current (AC) passes through a magnetic field and an electrical current is generated which is passed to the batteries of the aircraft, vehicle or automobile after converting the same to a direct current. The alternator consists of a stator—a stationary set of wire coil windings, inside which a rotor revolves. The rotor is an electromagnet supplied with a small amount of electricity. The presence of the electromagnet boosts the output of the electric current for charging the battery or creating force in the system. The power supplied to the alternator is quickly changed since the magnetic field is also quickly changed by controlling the amount of electric current in the winding of the electromagnet disposed on the armature of the alternator.

The turbo fan of the present invention provides the desired thrust via the plurality of vents. More specifically, the turbo fan releases the air present in the chamber in which the turbo fan is housed in through the plurality of vents to move the aircraft, watercraft or vehicle in a desired direction after reaching a pre-determined threshold.

The propulsion system of the present invention is particularly advantageous because it does not use fossil fuels (or a reduced amount of fossil fuels) and depends on electromagnets and sensors to power the alternator which in turn powers the batteries of the aircraft or vehicle. The movement of the aircraft or vehicle is dependent on the automated system, and the release of relatively high heat and pressure air via the plurality of vents. The propulsion system of the present invention can be easily and efficiently manufactured and marketed and is of a durable and reliable construction and can withstand the high pressures associated with delivering significant thrust. Further, the propulsion system reduces air pollution by replacing conventional internal combustion engines. Finally, the propulsion system has a lower weight compared to conventional combustion engines which also helps in increasing the efficiency of the vehicle.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the electromagnetic propulsion system of the present invention in accordance with the disclosed architecture;

FIG. 2 illustrates a perspective view of a volume of compressed air entering into the chamber from the turbo fan of one potential embodiment of the electromagnetic propulsion system of the present invention in accordance with the disclosed architecture.

FIG. 3 illustrates a perspective view of a volume of compressed air exiting the chamber through a vent of one potential embodiment of the electromagnetic propulsion system of the present invention in accordance with the disclosed architecture.

FIG. 4 illustrates a relational and perspective view of one potential embodiment of the electromagnetic propulsion system of the present invention in accordance with the disclosed architecture and its relationship to a battery for a vehicle; and

FIG. 5 illustrates a perspective view of an aircraft using one potential embodiment of the electromagnetic propulsion system of the present invention in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention or do not limit the scope of the invention. Additionally, an illustrated embodiment need not have all the aspects or advantages shown. Thus, in other embodiments, any of the features described herein from different embodiments may be combined.

As noted above, there is a long felt need in the art for an electromagnetic propulsion system for use with an aircraft, vehicle, watercraft, and the like. There is also a long felt need in the art for an electromagnetic propulsion system that does not rely solely on fossil fuels for power, and that is powered in part by the electricity generated by a plurality of electromagnets used in a power generation system. Additionally, there is a long felt need in the art for an electromagnetic propulsion system that utilizes a plurality of electromagnets having sensors to turn on, turn off and monitor an alternator and its performance of the system. Moreover, there is a long felt need in the art for an electromagnetic propulsion system that is environmentally friendly, and that can be used in a plurality of different applications, such as in aircraft, automobiles, watercraft, heavy equipment and the like. Finally, there is a long felt in the art for an electromagnetic propulsion system that is relatively inexpensive to manufacture, and that uses a plurality of electromagnets to generate and help power an alternator, which in turn provides power to the vehicle's battery or batteries.

The present invention, in one exemplary embodiment, is an electromagnetic propulsion system device for use in aircraft, vehicles and automobiles comprising an alternator and a turbo fan. The alternator is connected to the turbo fan through a shaft or other drive connection, and a plurality of electromagnets are provided for powering the alternator and propelling the turbo fan. The electromagnets have sensors to detect the position of the electromagnets on the armature of the alternator in real time. The alternator powers the batteries and the turbo fan in order to create air in a chamber which is then vented out and used to propel the aircraft or vehicle after a particular threshold of pressure has been reached.

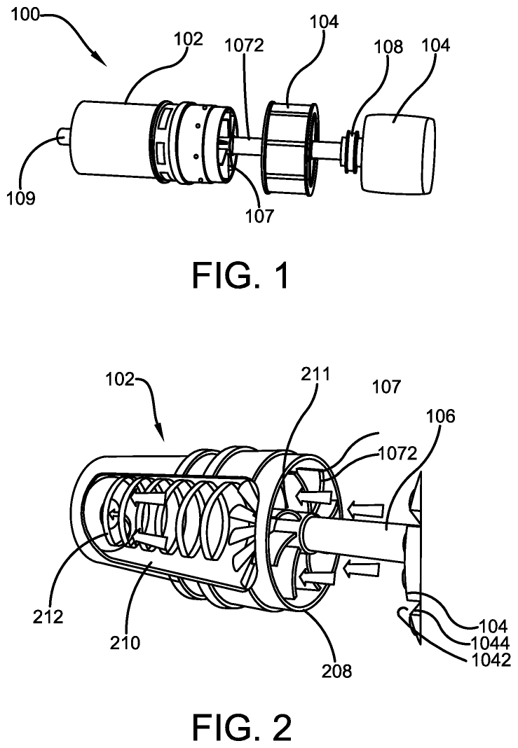

Referring initially to the drawings, FIG. 1 illustrates a perspective view of one potential embodiment of the electromagnetic propulsion system 100 of the present invention in accordance with the disclosed architecture. More specifically, the system 100 comprises a chamber 102, an alternator 104 having an armature 105, a fan 207, a nozzle or vent 109, a plurality of electromagnets 1042, and a plurality of sensors 1044, wherein the fan 107 is comprised of a plurality of blades 1072 and is connected to a shaft 106 that is driven by the alternator 104. The alternator 104 is provided on the outer periphery with a rotor inside which rotates and alternating current (AC) passes through a magnetic field to generate an electrical current which is passed to the batteries of the aircraft, vehicle or watercraft after converting the same to direct current.

The electromagnets 1042 power the alternator 104 that drives the turbo fan 107. The turbo fan 107, in turn, creates a relatively high pressure and temperature within the chamber 102 to provide the desired thrust once released from the chamber via the nozzle or vent 109. More particularly, the chamber 102 and its cavity 210 combine to create a conically shaped vortex of the incoming air flow 212, and drive the air flow 212 towards the nozzle or vent 109 disposed at the end of the chamber 102, as explained more fully below. In a preferred embodiment, the chamber 102 covers the whole bottom of the craft in which the series of fans 107 is located inside the chamber 102.

The blades 1072 of the fan 107 are preferably comprised of a titanium, nickel and/or other metal alloys. During operation, the blades 1072 are subjected to relatively high heat and pressure, as well as particles introduced by the air entering the chamber 102 and cavity 210, the blades 1072 can be eroded and damaged over time. As such, the blades 1072, as well as other components of system 100 that may be subjected to the erosive atmosphere, are preferably coated with a thermal barrier and/or anti-corrosive materials to increase the longevity of the same. One such overlay is MCrAlY, which is a corrosion resistant composition that may applied to the components of the system 100 by either physical vapor deposition (PVD) techniques or by plasma spraying. More specifically, the M of MCrAlY stands for either Ni or Co, or a combination of both (when applied to steels, it can also be Fe), depending on the type of superalloy. The Cr provides hot-corrosion resistance, but the amount that can be added is limited by the effect it is expected to have on the substrate, and the formation of Cr-rich phases in the coating. Aluminum (Al) content is preferably around 10-12% by weight, and the amount of yttrium (Y) is preferably around 1% by weight, which enhances adherence of the oxide layer.

As previously stated, the heated and compressed air 212 is exhausted from the vent 109, and provides a motive force to facilitate the movement of the aircraft, vehicle, watercraft, etc. An armature pulley 108 is also present to facilitate rotation of the armature 105 during startup of the system 100. The shaft 106 has a two or three ratio to the armature 105 on the alternator 104, and the chamber 102 is generally cylindrical in shape with a rounded periphery. The fan 107 rotates about a longitudinal axis of the chamber 102, with the blades 1072 extending radially outwardly from the axis of rotation, and with the tips of the blades 1072 immediately adjacent to the outer limits of the chamber 102. The air 212 received by the turbo fan 107 from the energy of the armature 105 on the alternator 1044 is then subjected to relative high pressure and temperature inside the chamber 102 before being expelled through the vent 108.

FIG. 2 illustrates a perspective view of a volume of compressed air entering into the chamber 102 from the turbo fan 107 of one potential embodiment of the electromagnetic propulsion system 100 of the present invention in accordance with the disclosed architecture. The turbo fan 107 is present at a proximal end 208 of the chamber 102, and rotates in a counter clockwise direction 211 at a very high rotating speed (i.e., in excess of 10,000 RPMs) to compress the air 212 when it enters into a chamber 102. More specifically, the air 212 received by the turbo fan 107 is subjected to very high pressure due to the rotation of the turbo fan 107, and then the air 212 enters into the cavity 210 of the chamber 102 where it is compressed before being expelled via the vent or nozzle 109. The air is drawn into the chamber 102 and the opening for the chamber 102 has a diameter that is larger than the diameter of the nozzle or vent 109, such that the air is further compressed and the force of exiting the vent 109 further contributes to the propulsive forces.

The turbo fan 107 is propelled using electromagnets 1042 disposed around the periphery of the alternator 104. The high-pressure air 212 inside the chamber 102 is caused due to the rotation of the turbo fan 107, and creates the desired thrust for the aircraft, watercraft or other vehicle. The rotation of the turbo fan 107 is monitored by the sensors 1044 disposed on the electromagnets 1042, and by monitoring a position of the electromagnets 1042 on the armature 105 of the alternator 104. The sensors 1044 are used to provide feedback to a computer, system or other processor (not shown) used in monitoring the propulsion system 101 and its performance or other criteria that may be selected for the particular system. More specifically, the sensors 1044 sense and provide information relating to a number of different parameters including, without limitation, a position, speed, pressure, temperature, air flow velocity, air particulate information, component wear and the like.

The fan 107 is mounted for rotation about an axis with the blades extending radially outwardly from the axis of rotation and with the tips adjacent an outer extremity of the chamber 102. The sensors 1044 that are positioned on the electromagnets 1042 are magnetically coupled to the blades 1072 of the fan 107, and aligned with the blades 1072 during the rotation of the fan 107. In an alternate embodiment, the blades 1072 may have one of a permanent magnet or an electromagnet 1042 at the tip of one or more or each of the blades 1072 for coupling with the sensors 1044.

The relatively high pressure and high heat air created by the turbo fan 107 combines the high-speed capability of the pure turbojet with the high efficiency and good acceleration characteristics of the propeller. Additionally, the turbo fan 107 may have a spool, compressor and/or a turbine rotating at a speed in accordance with the rotating speed of the turbo fan 107. In one embodiment, a series of turbo fans 107 may be used. In an alternative embodiment, the turbo fan 107 used in the present invention can also work similar to that of a high-bypass turbo fan or a low-bypass turbo fan, as per the requirements and application of the aircraft. For example, the turbo fan 107 may function as a high-bypass type, which has a by-pass ratio of 9 or 10 when employed in commercial aviation jet engines, or as a low-bypass when employed in modern military fighter engines, which have a by-pass ratio of 0.3 to 0.5.

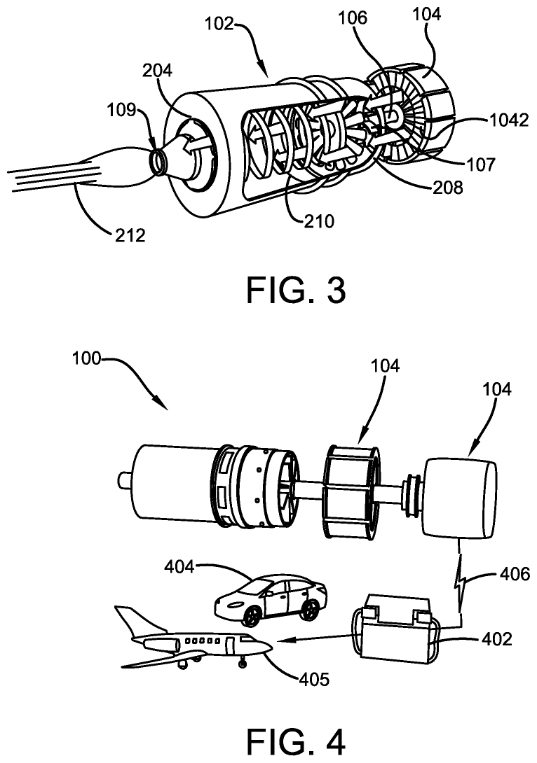

FIG. 3 illustrates a perspective view of a volume of compressed air 212 existing the chamber 102 through a vent 109 in one potential embodiment of the electromagnetic propulsion system 100 of the present invention in accordance with the disclosed architecture. More specifically, the chamber 102 has a turbo fan 107 at a proximal end 208 of the chamber 102, and the proximal end 208 is connected to an alternator 104 through a shaft 106. The electromagnets 1042 disposed on and around the periphery of the alternator 104 propel the turbo fan 107 to create the desired thrust for the aircraft, watercraft or vehicle. At the distal end 204 of the chamber 102, a vent 109 or nozzle is present to release the high-pressure air 212 and heat present in the chamber 102 and to manipulate the movements of the aircraft, watercraft or the vehicle. The system 100 of the present invention derives the thrust from the turbo fan 107. More specifically, the chamber 102 has at least one single stage turbo fan 107 which generates a high volume of air stream 212 inside the chamber 102 at a relatively high temperature and pressure. The fans 107 collect air inside of the chamber 102 to build pressure within the chamber 102.

In one embodiment, the air 212 created by rotating the turbo fan 107 in the cavity 210 of the chamber 102 compresses and accelerates the air, and is used to manipulate movements for the aircraft or vehicle. The shaft 106 has a two or three ratio to the armature 105 on the alternator 104, and the ratio is managed through the armature pulley 108 which serves similar to a clutch on an automobile. The air 212 within the chamber 102 is circulated and moved in a direction towards the distal end 204 of the chamber 102 at a relatively high speed, e.g., somewhere between 300 and 600 mph, because of the rotating effect of the turbo fan 107 and causes the air 212 to be released from the vent or nozzle 109.

FIG. 4 illustrates a relational and perspective view of one potential embodiment of the electromagnetic propulsion system 100 of the present invention in accordance with the disclosed architecture and its relationship to a battery 402 for a vehicle 404. More specifically, the alternator 104 of the system 100 provides power to the batteries 402 deployed in an aircraft 405 or other vehicle 404. The alternator 104 is comprised of a stator, inside which a rotor revolves. The rotor is an electromagnet supplied with a small amount of electricity through carbon or copper-carbon brushes (contacts) touching two revolving metal slip rings on its shaft. The rotation of the electromagnet inside the stator coils generates much more electricity inside these coils which is transferred through a circuit 406 to the batteries 402 for the necessary power to be provided by the batteries 402. The alternator 104 provides the power to the batteries 402 to service the electrical and propulsion requirements of the aircraft 405 or other vehicle 404. The battery 402 powers and communicates with various internal electrical components such as an Engine Control Unit (ECU).

The alternator 104 of the present invention is compatible with batteries 402 to provide a 14- or 28-volt system. 14-volt systems utilize 12-volt batteries, and 28-volt systems utilize 24-volt batteries, or any other batteries of higher voltages used in the aircraft or vehicles. The alternating current produced by alternator 104 is converted to direct current through a series of diodes (not shown) before being transmitted to the batteries 402. Further, the sensors 1044 disposed on the electromagnets 1042 provide the position information of the electromagnets 1042 to a monitoring computing device to control the rotation of the rotor of the alternator 104 to change the amount of power transmitted to the batteries 402. More specifically, based on the positional information of the electromagnets 1042, the rotating speed of the rotor of the alternator 104 is controlled, to either increase or decrease its speed, or to stop the rotor altogether. In one embodiment, the batteries are not used to operate the craft, but are rather used to make sure the magnets remain turning on the shafts, as opposed to the fan blades. More specifically, the batteries are used to restart the magnets which turn the fans to create the pressure.

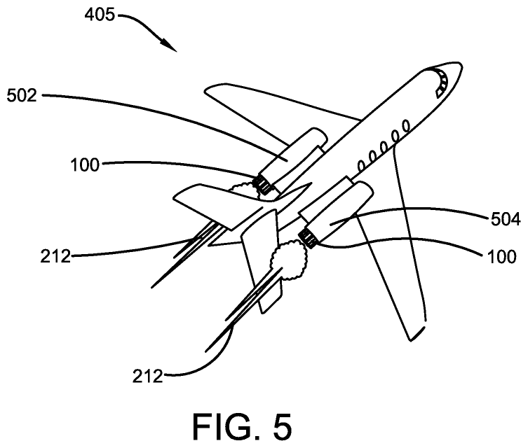

FIG. 5 illustrates a perspective view of an aircraft 405 using one potential embodiment of the electromagnetic propulsion system 100 of the present invention in accordance with the disclosed architecture. More specifically, the aircraft 405 is equipped with the electromagnetic propulsion system 100 of the present invention and receives the desired amount of thrust and/or movement without the use of additional fossil fuels. The aircraft 405 may have a first system 100 on its left wing 502, and a second system 100 on its right wing 504. Based on the amount of air 212 released from the vents 109 of chambers 102 of each system 100 present in the wings 502, 504 of the aircraft 405, a desired direction and movement is given to the aircraft 405 along with the thrust. In a similar manner, a vehicle 404 can also use the system 100 of the present invention to get a desired speed and direction without the use of additional fossil fuels.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Further, certain terms are used throughout the following description and claims to refer to particular features or components. As one skilled in the art will appreciate, different persons may refer to the same feature or component by different names. This document does not intend to distinguish between components or features that differ in name but not structure or function. As used herein “thrusters”, “propulsion device”, “modified propulsion system”, and “propulsion system” are interchangeable and refer to the electromagnetic propulsion system 100 of the present invention.

Notwithstanding the forgoing, the components of the improved and efficient propulsion system of the present invention can be of any suitable size and configuration as is known in the art without affecting the overall concept of the invention, provided that it accomplishes the above stated objectives. One of ordinary skill in the art will appreciate that the size, configuration and material of improved and efficient propulsion system as shown in the FIGS. are for illustrative purposes only, and that many other sizes of components of the propulsion system are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An electromagnetic propulsion system for producing a propulsive force comprising:
an alternator, a chamber, a shaft and a fan, wherein the shaft is connected to the fan, and the alternator comprises an armature having a plurality of electromagnets positioned on the armature;
each of the plurality of electromagnets having at least one sensor for determining the position of the alternator; and
wherein the fan is disposed within the chamber for compressing air drawn into a cavity of the chamber via an opening, and further wherein the compressed air is expelled through a vent that is smaller in size than the first opening.

2. The electromagnetic propulsion system for producing a propulsive force of claim 1, wherein the electromagnetic propulsion system is connected to a battery for storing energy for starting and powering the electromagnetic propulsion system.

3. The electromagnetic propulsion system for producing a propulsive force of claim 1, wherein the chamber, the shaft, and the vent are coated with MCrAlY.

4. The electromagnetic propulsion system for producing a propulsive force of claim 1, wherein each of the chamber, the vent, and the fan are made from one of a titanium, a nickel or a metal alloy.

5. The electromagnetic propulsion system for producing a propulsive force of claim 1, wherein the fan further comprises a plurality of blades coated with MCrAlY.

6. The electromagnetic propulsion system for producing a propulsive force of claim 1, wherein the at least one sensor gathers information relating to at least one of a position, a speed, a pressure, a temperature, an air flow velocity, an air particulate information, and a component wear relative to the alternator.

7. The electromagnetic propulsion system for producing a propulsive force of claim 1 further comprising a pulley to facilitate rotation of the armature.

8. The electromagnetic propulsion system for producing a propulsive force of claim 1, wherein the cavity creates a conically shaped vortex of air that is directed towards the vent, and further wherein the vent is positioned on an opposite end of the chamber from the opening.

9. The electromagnetic propulsion system for producing a propulsive force of claim 1, wherein the chamber has a proximal end adjacent to the alternator and a distal end adjacent to the vent.

10. The electromagnetic propulsion system for producing a propulsive force of claim 1, wherein the at least one sensor is positioned on each of the plurality of electromagnets, and further wherein the plurality of electromagnets are magnetically coupled to a plurality of blades of the fan.

11. The electromagnetic propulsion system for producing a propulsive force of claim 1, wherein the fan comprises a plurality of blades, and further wherein each of the plurality of blades comprises at least one of the plurality of electromagnets.

12. An electromagnetic propulsion system for an aircraft comprising:
an alternator, an armature enclosed within the alternator, a fan, a chamber and a vent, wherein the fan is comprised of a plurality of blades and is connected to a shaft that is driven by the alternator;
a plurality of electromagnets disposed about a periphery of the alternator; and
a plurality of sensors magnetically coupled to the plurality of blades, wherein the plurality of sensors sense information relating to at least one of a position, a speed, a pressure, a temperature, an air flow velocity, an air particulate information, and a component wear of electromagnetic propulsion system.

13. The electromagnetic propulsion system for an aircraft of claim 12, wherein a surface of each of the plurality of blades, the chamber, and the vent are coated with MCrAlY.

14. The electromagnetic propulsion system for an aircraft of claim 12, wherein the chamber has a proximal end adjacent to the alternator and a distal end adjacent to the vent.

15. The electromagnetic propulsion system for an aircraft of claim 12, wherein the plurality of sensors are aligned with the plurality of blades during rotation of the fan.

16. The electromagnetic propulsion system for an aircraft of claim 12, wherein the chamber has a cavity to create a conically shaped vortex from an incoming air flow and drive the incoming air flow towards the vent disposed at an end of the chamber opposite an end for introduction of the incoming air flow.

17. The electromagnetic propulsion system for an aircraft of claim 12 further comprising a pulley to facilitate rotation of the armature.

18. A motive force generator comprising:
an alternator, an armature enclosed within the alternator, a fan, a chamber and a vent, wherein the fan is comprised of a plurality of blades and the fan is connected to a shaft that is driven by the alternator;
a pulley to facilitate rotation of the armature;
a plurality of sensors magnetically coupled to the plurality of blades of the fan, wherein the plurality of sensors sense information relating to at least one of a position, a speed, a pressure, a temperature, an air flow velocity, an air particulate information, and a component wear of the motive force generator; and
a motive force of air generated by the motive force generator and expelled through the vent.

19. The motive force generator of claim 18, wherein each of the plurality of blades, the fan, the vent and the chamber are coated with an anti-corrosion coating.

20. The motive force generator of claim 18, wherein the chamber has a cavity to create a conically shaped vortex from an incoming air flow and drive the incoming air flow towards the vent disposed at an end of the chamber opposite an end for introduction of the incoming air flow to create the motive force.
